(19) United States
(12) Patent Application Publication
(10) Pub. No.: US 2019/0188694 A1
(43) Pub. Date: Jun. 20, 2019

(54) PAYMENT SYSTEMS AND METHODS WITH CARD-ON-FILE TOKENIZATION

(71) Applicant: MasterCard International Incorporated, Purchase, NY (US)

(72) Inventors: Gautam Uppalapati, O'Fallon, MO (US); Smita Sebastian, St. Louis, MO (US); Joshua Nathan Anderson, St. Peters, MO (US); Sowmya Reddy Lakka, Wildwood, MO (US)

(21) Appl. No.: 15/845,658

(22) Filed: Dec. 18, 2017

(51) Int. Cl. G06Q 20/38; G06Q 20/12

(52) U.S. Cl. CPC G06Q 20/385; G06Q 20/20; G06Q 20/382; G06Q 20/12

(57) ABSTRACT

A merchant computer system receives a first token transmitted to the merchant computer system from a customer device. A request for a second token is transmitted from the merchant computer system to a payment processor computer. The request includes the first token. The merchant computer system receives the second token that it requested. The second token is different from the first token. The merchant computer system transmits a payment account system transaction request to the payment processor computer. The latter request includes the second token.

### BACKGROUND

FIG. 1 is a block diagram that illustrates a conventional payment system 100.

The system 100 includes a customer device 102 by which a user 103 accesses an e-commerce server 104 via the internet 105. The customer device 102 may be any type of computing device usable to allow access to the internet, and runs a browser program (not separately shown) to enable interaction between the customer device 102 and the various resources available via the internet. The customer device 102 may be, for example, a personal computer, a laptop computer, a tablet computer or a mobile-browser-equipped smartphone or other mobile device. The e-commerce server 104 is typically a server computer operated by or on behalf of a merchant to host an online store/shopping website and to allow virtual visits to the website from customer devices. The e-commerce server 104 also operates to handle online-shopping transactions, typically funded by a payment system account owned by the user 103. In an online shopping transaction, the user 103 operates the customer device 102 to select one or more items for purchase, then elects to enter a checkout phase of the transaction, in which information that identifies the user's payment system account is provided to or accessed by the e-commerce server 104.

A computer 108 operated by an acquirer (acquiring financial institution) is also shown as part of the system 100 in FIG. 1. The acquirer may be a financial institution that provides payment account acceptance services to the merchant that operates the e-commerce server 104. The acquirer computer 108 may operate to receive an authorization request for the online shopping transaction from the e-commerce server 104. The acquirer computer 108 may route the authorization request via a payment network 110 (sometimes also referred to as a “card network”) to the server computer 112 operated by the issuer of the payment account that was specified during the checkout phase of the online shopping transaction. An authorization response generated by the payment account issuer server computer 112 may be routed back to the e-commerce server 104 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their e-commerce servers. The system may also include a very large number of payment account holders, who engage in online shopping transactions.

As is well known to those who are skilled in the art, a typical payment system like that shown in FIG. 1 may also handle numerous face to face purchase transactions at the point of sale in retail stores and other establishments. In a typical such transaction (not illustrated), the customer may present a payment card or other payment-enabled device (e.g., a payment-enabled mobile device) to a point of sale (POS) terminal. The POS terminal is operated by the merchant (or merchant's employee) to read payment account information from the card or device presented by the customer. A transaction authorization request may originate from the POS terminal for routing to the account issuer, and the authorization response may be routed back to the POS terminal from the account issuer.

Considering again the context of an online shopping transaction, in U.S. patent application Ser. No. 15/231,978 (which is commonly assigned herewith and which has common inventors herewith), there was disclosed a technique for executing an e-commerce transaction in which—in lieu of the purchaser providing a payment account number to the e-commerce server—the purchaser provides such information to a payment processing server via a payment information capturing module co-displayed with the merchant's checkout page display. The payment processing server then provides a token to the merchant for inclusion in the transaction authorization request message. The token is subsequently translated into a suitable token or payment account number for further routing in the payment system. The disclosure of the said '978 patent application is incorporated herein by reference.

The present inventors have now recognized an opportunity to apply payment information capture and tokenization to facilitate a card-on-file arrangement in which the merchant does not store highly sensitive payment account information.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates portions of a payment system provided according to aspects of the present disclosure.

FIG. 2A is a flow chart that illustrates a process that may be performed in connection with the payment system components illustrated in FIG. 2.

FIG. 3 is a block diagram that illustrates additional portions of the payment system partially shown in FIG. 2.

FIG. 4 is a simplified block diagram of a customer device that may perform a role in the payment system of FIGS. 2 and 3.

FIG. 5 is a block diagram that illustrates a computer system that may perform a role in the system of FIGS. 2 and 3.

FIG. 6 is a block diagram that illustrates another computer system that may perform a role in the system of FIGS. 2 and 3.

FIG. 7 is a flow chart that illustrates a process that may be performed in the system of FIGS. 2 and 3 according to aspects of the present disclosure.

FIG. 8 is a block diagram that illustrates a funds transfer system according to aspects of the present disclosure.

FIG. 9 is a flow chart that illustrates a process that may be performed in the system of FIG. 8 according to aspects of the present disclosure.

### DETAILED DESCRIPTION

In general, and for the purpose of introducing concepts of embodiments of the present disclosure, a payment account holder may enroll with a payment processor to obtain a token that may be used later to obtain another token or account identifier that more directly represents the account holder's payment system account. The former token may be referred to as a “temporary token”. The latter token or account identifier (which may be a DPAN (digital primary account number) or PAN (primary account number)) may be referred to as a “permanent” token, notwithstanding that it may be subject to change/replacement from time to time. The account holder may provide the temporary token to the merchant e-commerce system during an online shopping transaction in lieu of a payment account number. The merchant may communicate with the payment processor via a secure communication channel to use the temporary token to request the permanent token. The payment processor may provide the permanent token to the merchant. The merchant may then insert the permanent token in a transaction authorization request message to be routed in connection with the current online shopping transaction. If necessary, the permanent token may be translated in the payment system to fully identify the account holder's payment account for routing the transaction authorization request message to the issuer of the account holder's payment account. In some embodiments, it may be a requirement that a cryptogram be presented along with the permanent token to support a portion of the transaction in which funds are pulled from a payment system account. In some embodiments, the cryptogram and the token are stored on different servers to enhance security and reduce risks that could arise in the case of a data breach.

With an arrangement of this kind, the need for the merchant to hold sensitive account identification information may be reduced. This may improve security as to sensitive information, and may allow the merchant to be relieved from most or all of the expense and effort entailed by PCI (Payment Card Industry) data security compliance.

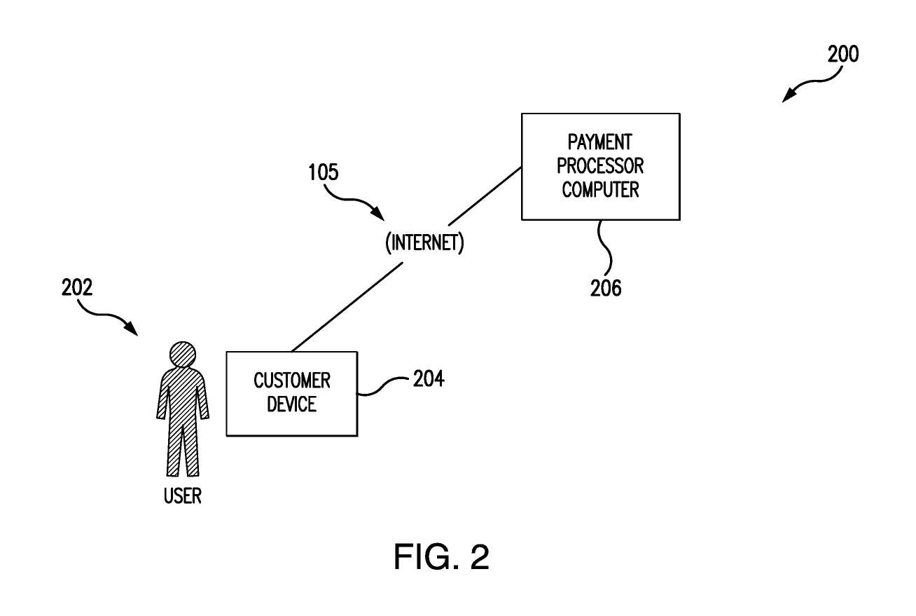

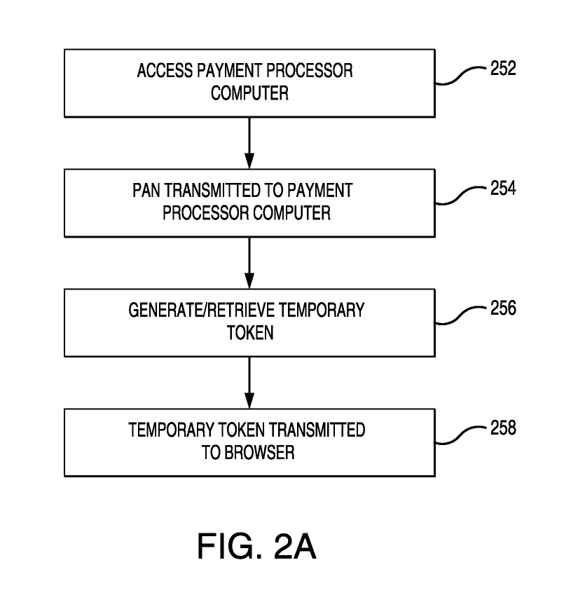

FIG. 2 is a block diagram that illustrates portions of a payment system 200 provided according to aspects of the present disclosure.

More specifically, FIG. 2 illustrates a user registration or set-up mode of operation in the payment system 200. In the registration set-up mode, the user 202 operates his/her customer device 204 to interact with a payment processor computer 206 via the internet 105. Typically the interaction between the customer device 204 and the payment processor computer 206 entails operation of a browser program (not separately shown in FIG. 2) that runs on the customer device 204. In portions of the ensuing discussion, actions of the browser may be ascribed to the customer device 204 and vice versa. In cases where the customer device 204 is a mobile device/smartphone, a mobile browser (not separately shown in FIG. 2) running on the customer device 204 may manage the interaction with the payment processor computer 206, and communications over-the-air via a mobile telephone network (not separately shown) may be involved in the interaction between the customer device 204 and the payment processor computer 206.

As illustrated in the flow chart shown in FIG. 2A, a user registration process may occur as follows. At block 252 in FIG. 2A, the user 202 may operate the customer device 204 to access the payment processor computer 206. At 254, the user 202 may provide his/her payment account number (e.g., a primary account number or “PAN”) to the payment processor computer 206 by transmitting the payment account number from the browser to the payment processor computer 206. For example, the user 202 may operate the customer device 204 to enter the account number in a payment information capturing module similar to that described in the above-mentioned commonly-assigned '978 patent application. At block 256, and in response to receiving the user's payment account number, the payment processor computer 256 may generate or retrieve from storage a temporary token for use in future online shopping activities. At 258, the payment processor computer 206 may transmit—to the browser—the temporary token generated or retrieved at 256. The token discussed in this paragraph may be viewed as “temporary” in the sense that it cannot be used directly (at least not successfully) in a transaction authorization request message. Rather, as will be seen, the temporary token may be useful only for a merchant to obtain a “permanent” token from the payment processor computer 206 via a secure communication channel. The payment processor computer 206 may store the temporary token in association with the user's payment account number and/or with one or more permanent tokens. As suggested above, the payment account number itself should be considered to fall within the meaning of the term “permanent token”.

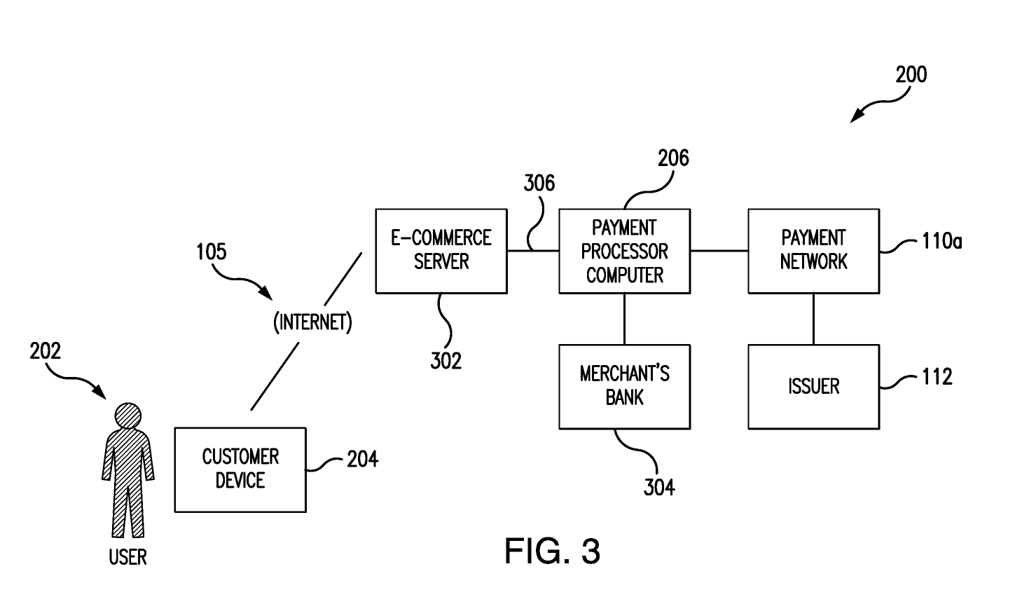

FIG. 3 is a block diagram that illustrates additional portions of the payment system 200, which was partially shown in FIG. 2.

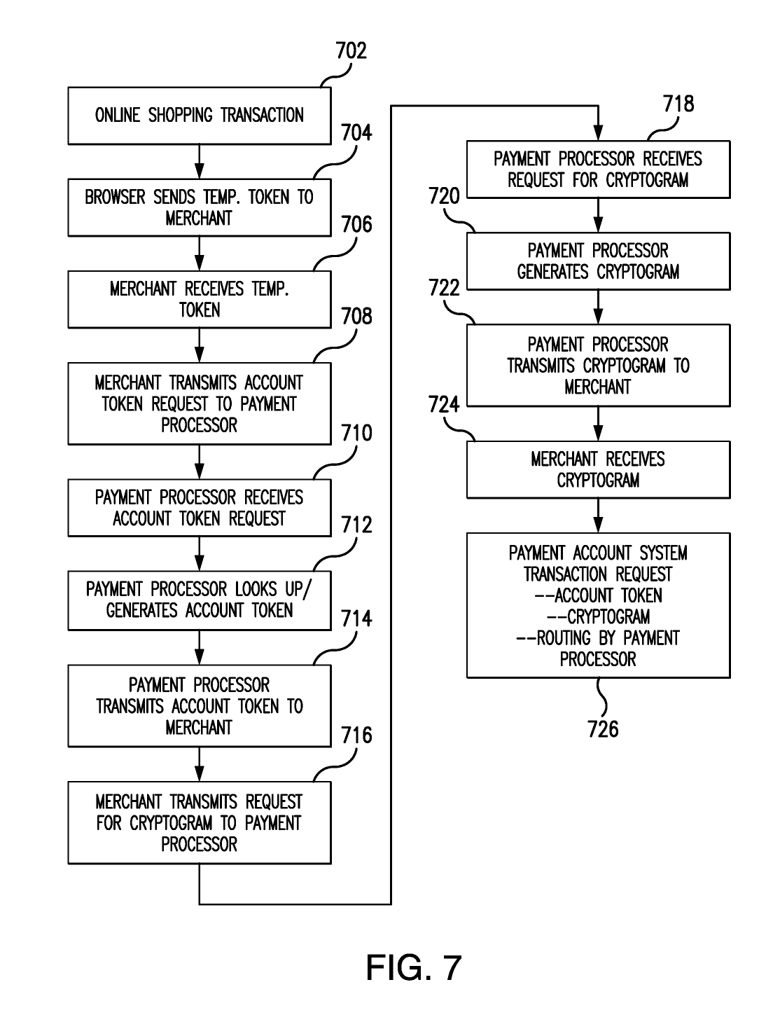

The payment system 200, as illustrated in FIG. 3, includes the previously mentioned customer device 204 (operated by the user 202) and payment processor computer 206. In the depiction of FIG. 3, the payment system further includes an e-commerce server computer 302, which may be operated by or on behalf of a merchant and which may be considered a “merchant computer system”. In FIG. 3, the user 202 is operating the customer device 204/browser to interact with the e-commerce server computer 302 to engage in an online shopping transaction via the internet. Details of the processing related to the transaction will be provided below, particularly in connection with FIG. 7. It will be appreciated that interaction between the browser and the e-commerce server computer 302 may be via a communication channel that includes a mobile communications network and/or the internet.

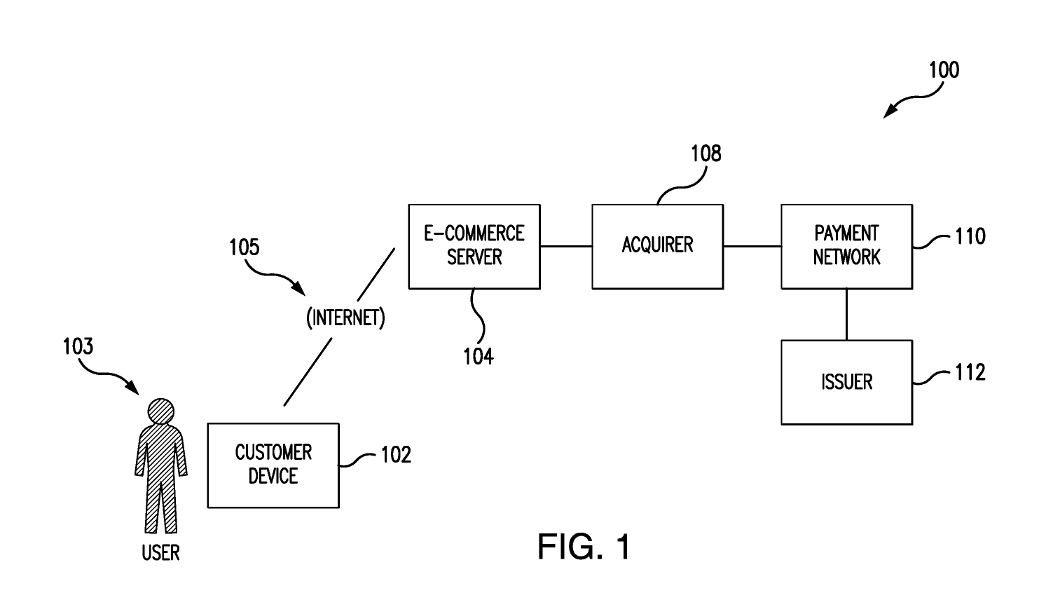

The merchant's bank 304 is also shown in FIG. 3. The merchant's bank 304 may may serve as recipient of funds to be transferred to the account of the merchant in connection with payment system account transactions conducted in the payment system 200. The payment network (reference numeral 110a) and the issuer 112 from FIG. 1 are also shown as components of the payment system 200. The payment network is given the revised reference numeral 110a in FIG. 3 to indicate the possibility that the payment network 110a may be somewhat modified from conventional operation of a payment network in order to interact with or possibly overlap with the payment processor computer 206 to support operation of the payment processor computer 206 as described herein. Moreover, in some embodiments, the payment processor computer 206 and the payment network 110a may be under common operation or control.

The communication channel 306 between the e-commerce server computer 302 and the payment processor computer 206 may be completely different from the channel by which the mobile device 204 and the e-commerce server computer 302 interact.

As was the case with the system as depicted in FIG. 1, FIG. 3 only shows components required for handling a single transaction. In a practical embodiment of the system 200, there may be numerous e-commerce servers, and customer devices, a large number of merchant's banks/acquirers and issuers, and potentially also a number of payment processors. The system 200 may also handle transactions at the point of sale, and so may include many items of POS equipment like those referred to above. Still further, the system 200 may include a very large number of customer payment devices, such as cards, fobs, payment-enabled mobile devices, etc., for use in initiating transactions at the point of sale.

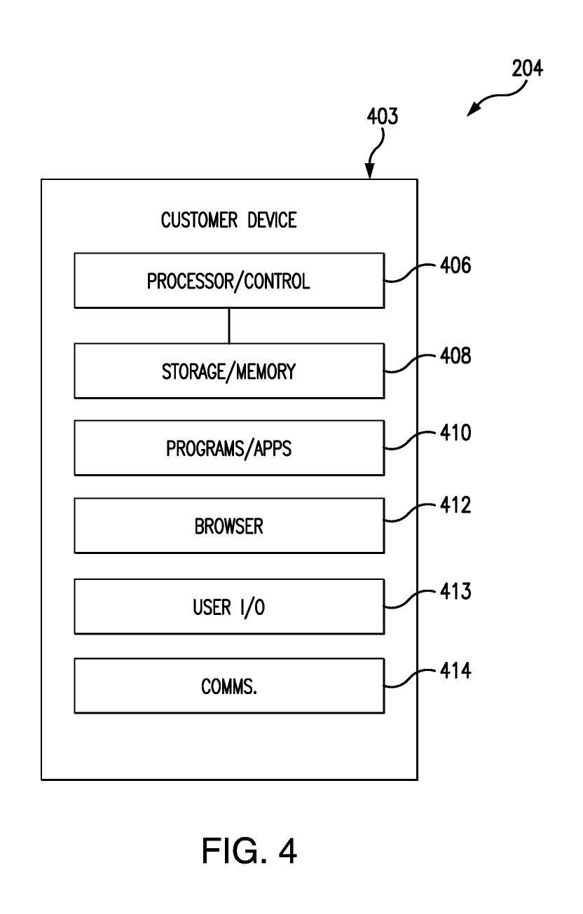

FIG. 4 is a simplified block diagram of an example of the customer device 204 shown in FIGS. 2 and 3.

The customer device 204 may include a housing 403. (In cases where the customer device 204 is a desktop computer, the housing 403 should be understood to represent several housings including the “tower” housing, the keyboard housing, etc.)

The customer device 204 further includes a processor/control circuit 406, which is contained within the housing 403. Also included in the customer device 204 is a storage/memory device or devices (reference numeral 408). The storage/memory devices 408 are in communication with the processor/control circuit 406 and may contain program instructions to control the processor/control circuit 406 to manage and perform various functions of the customer device 204. Programs/applications (or “apps”) that are stored in the storage/memory devices 408 are represented at block 410 in FIG. 4, and may be accessed to program the processor/control circuit 406.) In view of its pertinence to the teachings of this disclosure, a browser program is shown separately from the programs/apps 410 and is represented by block 412.

Physical and/or software aspects of the device user interface, including input/output (I/O) devices, are represented at block 413 in FIG. 4.

As is typical for computing devices, the customer device 204 may include communications components as represented by block 414 (FIG. 4). The communications components 414 allow the customer device 204 to engage in data communication with other devices. In cases where the customer device 204 is a mobile device, the communications components 414 may support mobile communications functions that include voice and data communications via a mobile communications network (not shown). The data communication capabilities of the customer device 204 may allow for online browsing sessions and interactions with webpages via the browser 412.

From the foregoing discussion, it will be appreciated that the blocks depicted in FIG. 4 as components of the customer device 204 may in effect overlap with each other, and/or there may be functional connections among the blocks which are not explicitly shown in the drawing.

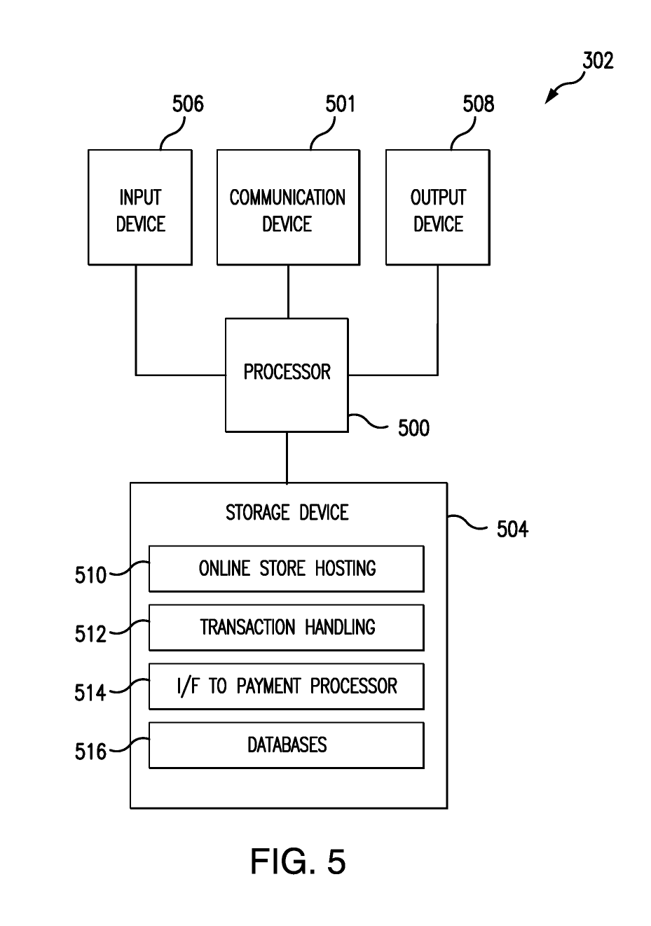

FIG. 5 is a block diagram that illustrates an embodiment of the e-commerce server computer 302 shown in FIG. 3.

Referring now to FIG. 5, the e-commerce server computer 302 may, in its hardware aspects, resemble a typical server computer and/or mainframe computer, but may be controlled by software to cause it to function as described herein. For example, the e-commerce server computer 302 may be constituted by commercially available server computer hardware and/or by cloud-based computing resources.

The e-commerce server computer 302 may include a computer processor 500 operatively coupled to a communication device 501, a storage device 504, an input device 506 and an output device 508. The communications device 501, the storage device 504, the input device 506 and the output device 508 may all be in communication with the processor 500.

The computer processor 500 may be constituted by one or more conventional processors. Processor 500 operates to execute processor-executable steps, contained in program instructions described below, so as to control the e-commerce server computer 302 to provide desired functionality.

Communication device 501 may be used to facilitate communication with, for example, other devices (such as customer devices and the payment processor computer 206 (FIG. 3)). For example (and continuing to refer to FIG. 5), communication device 501 may comprise numerous communication ports (not separately shown), to allow the e-commerce server computer 302 to communicate simultaneously with a large number of other devices, including communications as required to simultaneously handle numerous online shopping transactions.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the e-commerce server computer 302, executed by the processor 500 to cause the e-commerce server computer 302 to function as described herein.

The programs may include one or more conventional operating systems (not shown) that control the processor 500 so as to manage and coordinate activities and sharing of resources in the e-commerce server computer 302, and to serve as a host for application programs (described below) that run on the e-commerce server computer 302.

The programs stored in the storage device 504 may also include an online store hosting application program 510 that programs the processor 500 to enable the e-commerce server computer 302 to host a webpage or pages required to present via the interne an online store for access by prospective customers.

The storage device 504 may also store a transaction handling application program 512. The transaction handling application program 512 may overlap with the application program 510 and may program the processor 500 to enable the e-commerce server computer 302 to handle numerous online shopping/e-commerce transactions initiated by visitors to the online store sponsored by the merchant that operates the e-commerce server computer 302.

Still further, the storage device 504 may store a software interface 514 that may facilitate communications between the e-commerce server computer 302 and the payment processor computer 206.

The storage device 504 may also store, and the e-commerce server computer 302 may also execute, other programs, which are not shown. For example, such programs may include a reporting application, which may respond to requests from system administrators for reports on the activities performed by the e-commerce server computer 302. The other programs may also include, e.g., database management software, one or more data communication programs, device drivers, etc.

The storage device 504 may also store one or more databases 516 required for operation of the e-commerce server computer 302.

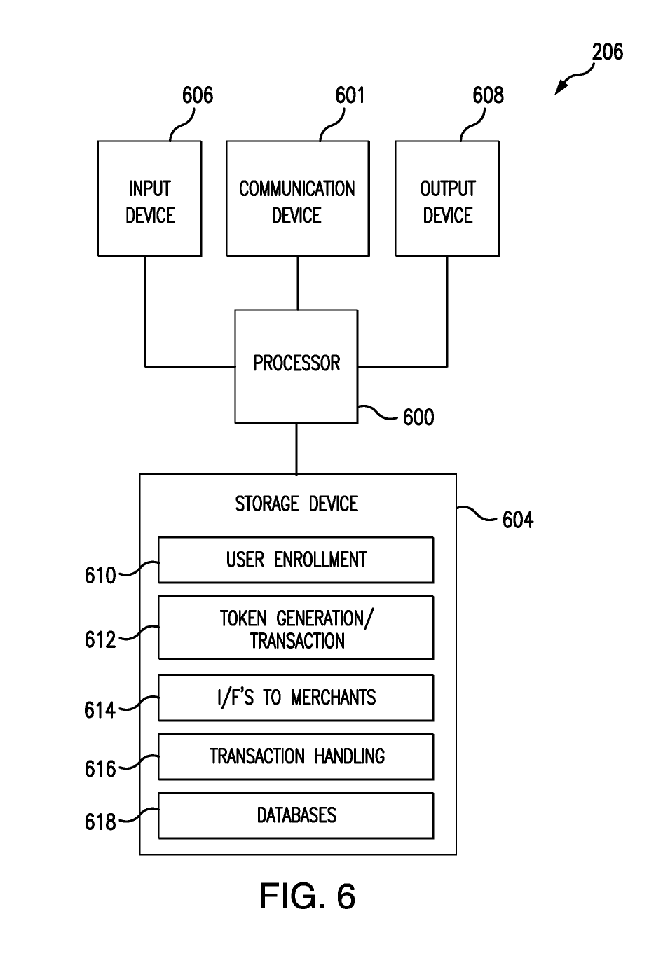

FIG. 6 is a block diagram that illustrates an embodiment of the payment processor computer 206. The payment processor computer 206 may resemble the above-described e-commerce server computer 302 in terms of hardware architecture and/or constituent components. Accordingly, the payment processor computer 206 may include a computer processor 600 operatively coupled to a communication device 601, a storage device 604, an input device 606 and an output device 608. The communications device 601, the storage device 604, the input device 606 and the output device 608 may all be in communication with the processor 600.

Processor 600 operates to execute processor-executable steps, contained in program instructions described below, so as to control the payment processor computer 206 to provide desired functionality.

Storage device 604 stores one or more programs for controlling processor 600. The programs comprise program instructions (which may be referred to as computer readable program code means) that contain processor-executable process steps of the payment processor computer 206, executed by the processor 600 to cause the payment processor computer 206 to function as described herein.

The programs may include one or more conventional operating systems (not shown) that control the processor 600 so as to manage and coordinate activities and sharing of resources in the payment processor computer 206, and to serve as a host for application programs (described below) that run on the payment processor computer 206.

The programs stored in the storage device 604 may also include a user enrollment application program 610. The user enrollment application program 610 may program the processor 600 to control the payment processor computer 206 such that the payment processor computer 206 operates to permit individual payment card account holders to register as users of the “card on file” functionality of the payment processor computer 206. Details of such functionality are described herein.

The storage device 604 may further store a token translation and/or generation software module 612. The software module 612 may program the processor 600 such that the payment processor computer 206 is enabled to look up and/or generate required token values in response to requests for tokens and/or to translate tokens into account indicators such as payment account numbers.

The programs stored in the storage device 604 may also include a software interface 614 for facilitating data communications between the payment processor computer 206 and a considerable number of merchant computers (of which the e-commerce server computer 302 is one example).

The storage device 604 may also store a transaction handling application program 616. The transaction handling application program 616 may program the processor 600 to enable the payment processor computer 206 to handle numerous payment account system transactions and/or requests for the same containing tokens as described below.

The storage device 604 may also store, and the payment processor computer 206 may also execute, other programs, which are not shown. For example, such programs may include a reporting application, which may respond to requests from system administrators for reports on the activities performed by the payment processor computer 206. The other programs may also include, e.g., database management software, one or more data communication programs, device drivers, etc.

The storage device 604 may also store one or more databases 618 required for operation of the payment processor computer 206.

FIG. 7 is a flow chart that illustrates a process that may be performed in the payment system 200 according to aspects of the present disclosure.

At 702 in FIG. 7, the user 202 operates his/her customer device 204/browser 412 to engage in an online shopping transaction via interaction between the browser 412 and the e-commerce server computer 302. It is assumed that the user 202 selects one or more items for purchase in the transaction, and proceeds to the checkout phase of the online shopping transaction.

At 704, the user 202 communicates to the e-commerce server computer 302, via the browser 412, the temporary token obtained by the user 202 during registration with the payment processor computer 206, it being understood that the temporary token in question represents (indirectly) the payment account belonging to the user that the user wishes to employ to settle the current online shopping transaction.

At 706, the e-commerce server computer 302 receives the temporary token transmitted at 704 from the browser to the e-commerce server computer 302.

At 708, the e-commerce server computer 302 transmits—to the payment processor computer 206—a request for a payment account token to be included in a forthcoming transaction authorization request message from the e-commerce server computer 302 for the current online purchase transaction. It may be assumed that the communication channel between the e-commerce server computer 302 and the payment processor computer 206 is strongly secured from interception. For example, the communication channel may consist of dedicated communication assets protected from interception or may otherwise be secured well-beyond whatever security is typical in internet communications. It is also to be understood that the request for a payment account token transmitted at 708 by the e-commerce server computer 302 includes the temporary token received at 706. In some embodiments, communications between the e-commerce server computer 302 and the payment processor computer 206 may be via a suitable API (application programming interface).

At 710, the payment processor computer 206 receives the request for a payment account token.

At 712, the payment processor computer 206 looks up or generates a “permanent” token—i.e., a token that is usable in a transaction authorization request message. In some embodiments, the payment processor computer 206 uses the temporary token received at 710 to look up a previously assigned token that represents the user's payment account. (In some situations, the permanent token may be the PAN (primary account number) for the user's account or a so-called “DPAN”—i.e., a digital PAN.) In some embodiments, the generated or looked up token may be dedicated to use only for online purchase transactions from the merchant that operates the e-commerce server computer 302. The payment processor computer 206 may store (or have previously stored) the token in association with the user's payment account, which the payment processor computer 206 may have determined based on the temporary token that it received. (In cases where the token is a DPAN, there may be a requirement that a cryptogram, as discussed below, be presented through the payment system with the DPAN to support pulling funds from the corresponding payment system account.)

At 714, the payment processor computer 206 may transmit the permanent token to the e-commerce server computer 302. It again may be the case that the highly secure communication channel described above may be used for this transmission. Block 714 may also be taken to represent the e-commerce server computer 302 receiving the permanent token.

In some embodiments and/or in some situations, it may be desirable or required for additional security that the e-commerce server computer 302 submit a cryptogram as part of the transaction authorization request message for the online purchase transaction. Accordingly, at 716, the e-commerce server computer 302 may transmit a request for a cryptogram to the payment processor computer 206. This request may include the permanent token received by the e-commerce server computer 302 from the payment processor computer 206.

At 718, the payment processor computer 206 receives the request for a cryptogram.

At 720, the payment processor computer 206 may generate the cryptogram.

The permanent token as provided by the e-commerce server computer 302 may be one of the inputs to the calculation by which the payment processor computer 206 generates the cryptogram. In some embodiments, the cryptogram may be generated in accordance with practices of the DSRP (Digital Secure Remote Payments) service offering provided by Mastercard International Incorporated.

At 722, the payment processor computer 206 transmits the cryptogram to the e-commerce server computer 302.

At 724, the e-commerce server computer 302 receives the cryptogram from the payment processor computer 206.

At 726, the e-commerce server computer 302 generates and transmits—to the payment processor computer 206—a payment account system transaction authorization request message. This message may resemble the authorization request referred to above in connection with FIG. 1, except that—in the case of the process block 716—the payment account for the authorization request is identified by the permanent token just received by the e-commerce server computer 302 from the payment processor computer 206. Moreover, the transaction authorization request message may include the cryptogram received by the e-commerce server computer 302 at 724. The transaction authorization request may then be routed via the payment processor computer 206 and the network 110a to the issuer 112. If necessary, the permanent token may be translated to facilitate the routing of the transaction authorization request message. The token translation may occur via one or more of the payment processor computer 206, the payment network 110a and/or a token vault (not shown). Other customary actions may also be taken with respect to the requested transaction, including “AVS” (address verification system processing), and authorization issued from the issuer 112.

With use of the temporary and permanent tokens as described herein, the merchant (via the e-commerce server computer 302) may have little or no reason or opportunity to have highly sensitive payment account information in its possession at any time, or may only have such information for a limited time. This may minimize or eliminate the risk that such information could be compromised via a breach of the merchant's data systems. Consequently, it may be feasible and/or permissible to relieve the merchant from most or all requirements for PCI data security. This may produce a significant savings for the merchant in terms of expense and effort related to data security.

It should be understood that in some embodiments of the process of FIG. 7, the actions related to the cryptogram may be omitted.

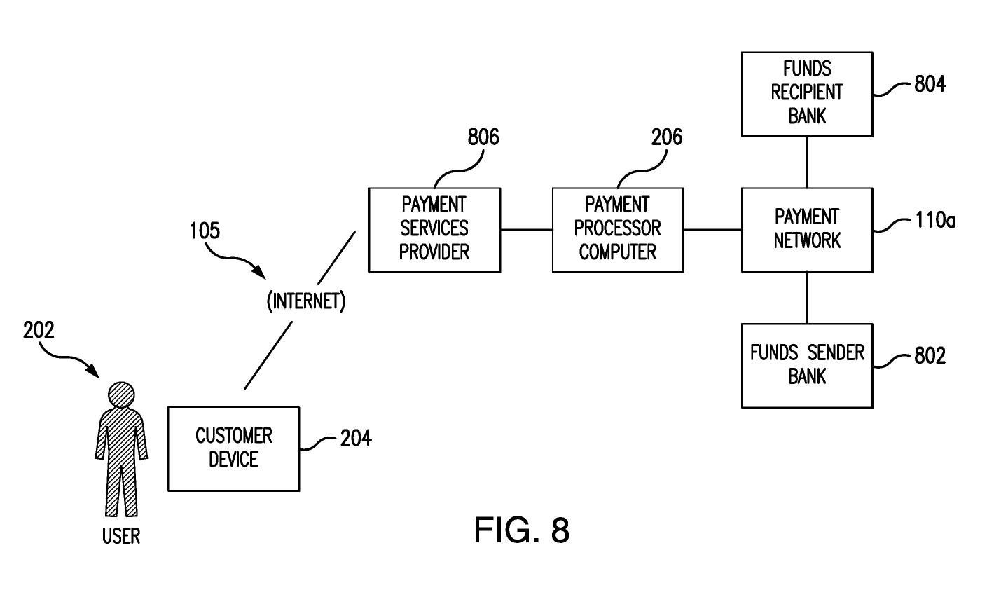

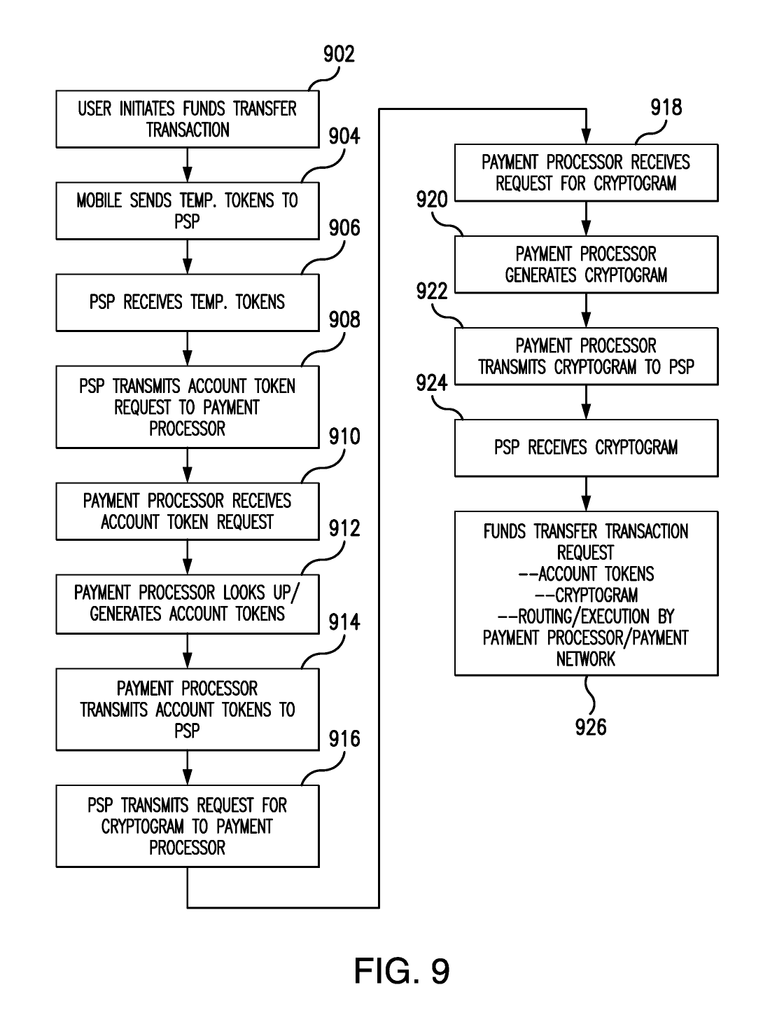

As is well-known to those who are skilled in the art, payment account systems may be utilized for so-called “P2P” (person to person) remittance transactions as well as for payments by customers to merchants. One example of a payment-account-system-based remittance system is described in U.S. Pat. No. 8,396,793, which is commonly assigned with this disclosure. Principles of the present disclosure are applicable to such a remittance system, as will now be described with reference to FIGS. 8 and 9. The disclosure of the above-mentioned '793 patent is incorporated herein by reference.

Referring initially to FIG. 8, a remittance system 800 includes a payment network 110a, a remittance sender's bank 802 and a remittance recipient's bank 804.

A user 202 and his/her customer device 204 are again shown in FIG. 8 (as in FIG. 3). The customer device 204 is shown in FIG. 8 as being in communication with a payment services provider 806 via the internet 105 for the purpose of initiating a remittance/P2P funds transfer from the user 202 for the benefit of a funds transfer recipient who is not shown. Like the e-commerce server computer 302 in FIG. 3, the payment services provider 806 may interact with the payment processor computer 206 (which was also shown in FIG. 3) to largely or entirely shield the payment services provider 806 from contact with sensitive account information.

In contradistinction to a payment account transaction for a purchase from a merchant, a P2P payment account transaction may involve two payment accounts—i.e., the sender's account and the recipient's account—rather than one. Accordingly, it will be assumed for the ensuing discussion that prior to initiating the P2P transaction, the sender (user 202) has possession (e.g., in his/her browser 412) of two temporary tokens, of which the first represents (indirectly) the sender's payment account and the second represents (indirectly) the recipient's payment account.

FIG. 9 is a flow chart that illustrates a process that may be performed in the remittance system 800 according to aspects of the present disclosure.

At 902 in FIG. 9, the user 202 operates his/her mobile device 204 to initiate a remittance transaction via interaction between the mobile device 204 and the payment services provider 806. It is assumed that the user 202 indicates a monetary amount that is to be transferred in the remittance transaction.

At 904, the user 202 communicates to the payment services provider 806, via the mobile device 204, the two temporary tokens that respectively represent (indirectly) the user's payment account and the recipient's payment account

At 906, the payment services provider 806 receives the temporary tokens transmitted at 904 from the mobile device 204 to the payment services provider 806.

At 908, the payment services provider 806 transmits—to the payment processor computer 206—a request for the payment account tokens to be included in a forthcoming remittance request. In line with the above discussion in connection with block 708 in FIG. 7, it may be assumed that the communication channel between the payment services provider 806 and the payment processor computer 206 is strongly secured from interception.

At 910, the payment processor computer 206 receives the request for payment account tokens.

At 912, the payment processor computer 206 looks up or generates a “permanent” token—i.e., a token that is usable in a remittance request message—for each of the sender's payment account and/or the recipient's payment account. In some embodiments, the payment processor computer 206 uses the temporary tokens received at 910 to look up one or more previously assigned tokens that represents the payment accounts to be involved in the remittance. (In some situations, the permanent token(s) may be the PAN (primary account number) or PANs for the sender/recipient payment account or a so-called “DPAN”—i.e., a digitized PAN.) In some embodiments, the generated or looked up token(s) may be dedicated to use only for remittance requests from the payment services provider 806. The payment processor computer 206 may store (or have previously stored) the tokens respectively in association with the sender/recipient payment accounts, which the payment processor computer 206 may have determined based on the temporary tokens that it received.

(In situations where a permanent token had previously been obtained, the steps of this process relating to obtaining the permanent token may be omitted.)

At 914, the payment processor computer 206 may transmit the permanent tokens to the payment services provider 806. It again may be the case that the highly secure communication channel described above may be used for this transmission. Block 914 may also be taken to represent the payment services provider 806 receiving the permanent token.

As was the case with the process of FIG. 7, in some embodiments and/or in some situations, it may be desirable or required for additional security that the payment services provider 806 submit a cryptogram as part of the remittance transaction request. Accordingly, at 916, the payment services provider 806 may transmit a request for a cryptogram to the payment processor computer 206. This request may include the permanent tokens received by the payment services provider 806 from the payment processor computer 206.

At 918, the payment processor computer 206 receives the request for a cryptogram.

At 920, the payment processor computer 206 may generate the cryptogram.

The permanent tokens as provided by the payment services provider 806 may be included in the inputs to the calculation by which the payment processor computer 206 generates the cryptogram.

At 922, the payment processor computer 206 transmits the cryptogram to the payment services provider 806.

At 924, the payment services provider 806 receives the cryptogram from the payment processor computer 206.

At 926, the payment services provider 806 generates and transmits—to the payment processor computer 206—a request for a remittance transaction in accordance with the instructions provided by the user 202. The remittance request may use the two permanent tokens to specify the sending and receiving accounts for the remittance/funds transfer transaction. Moreover, the remittance request may include the cryptogram received by the payment services provider 806 at 924. The requested funds transfer may then be routed and executed via the payment processor computer 206 and the network 110a. If necessary, one or both of the permanent tokens may be translated to facilitate the routing and/or execution of the funds transfer.

It should be understood that in some embodiments of the process of FIG. 9, the actions related to the cryptogram may be omitted.

In some embodiments, the tokens referred to herein are all in the format of PANs as used in the payment system 200. For example, the tokens may each consist of a fixed number of decimal digits, such as 16 digits, 15 digits or 14 digits. In other words, in some embodiments, all tokens may be in the same format, which may aid in providing convenient operability of the payment system and/or may aid in compatibility with existing data formats.

It will be recalled that the term “DPAN” or “digital PAN” was employed in the previous discussion. As is known to those skilled in the art, a DPAN may be a 16-digit account number, or other account number, that cannot be used for completing a manual transaction over a voice call; rather a DPAN may be effective only when used in a transaction originating from a customer device with which it has been associated.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” and “payment system account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, in a merchant computer system, a first token transmitted to the merchant computer system from a customer device;
transmitting, from the merchant computer system to a payment processor computer, a request for a second token, the request including the first token;
receiving the requested second token in the merchant computer system, the second token different from the first token; and
transmitting a payment account system transaction request from the merchant computer system to the payment processor computer, the transaction request including the second token.

2. The method of claim 1, further comprising:
prior to the step of transmitting the transaction request:
transmitting a request for a cryptogram from the merchant computer system to the payment processor computer, the request for the cryptogram including the second token; and
receiving, by the merchant computer system, the requested cryptogram;
and wherein the transmitted transaction request includes the received cryptogram.

3. The method of claim 1, wherein:
the first token is received by the merchant computer system via a first communication channel and the merchant computer system receives the second token via a second communication channel different from the first communication channel.

4. The method of claim 3, wherein the first communication channel includes the internet and the second communication channel does not include the internet.

5. The method of claim 4, wherein the request for the second token is transmitted via the second communication channel.

6. The method of claim 1, wherein the second token is a DPAN (digitized primary account number).

7. The method of claim 1, wherein the merchant computer system is an e-commerce server.

8. A method comprising:
receiving, in a payment processor computer, a first request from a merchant computer system, the first request including a first token, the first request for requesting a second token;
transmitting the second token from the payment processor computer to the merchant computer system, the second token different from the first token; and
receiving a second request by the payment processor computer from the merchant computer system, the second request being a payment account system transaction request, the transaction request including the second token.

9. The method of claim 8, further comprising:
routing the received transaction request.

10. The method of claim 8, further comprising:
prior to receiving the transaction request:
receiving, in the payment processor computer from the merchant computer system, a request for a cryptogram, the request for the cryptogram including the second token; and
transmitting, by the payment processor computer to the merchant computer system, the requested cryptogram;
and wherein the received transaction request includes the received cryptogram.

11. The method of claim 8, further comprising:
using the first token to identify an account holder; and
using the second token to identify the account holder.

12. The method of claim 8, wherein the second token is a DPAN (digitized primary account number).

13. The method of claim 8, wherein the merchant computer system is an e-commerce server.

14. The method of claim 8, further comprising:
generating the second token in the payment processor computer in response to the first request.

15. A method comprising:
receiving a first request in a payment processor computer, the first request including a first token, the first request for requesting a second token;
transmitting the second token from the payment processor computer, the second token different from the first token; and
receiving a second request in the payment processor computer, the second request being a funds transfer request, the second request including the second token, the second token representing a payment system account, the funds transfer request for requesting one of: (a) a transfer of funds from the payment system account; and (b) a transfer of funds to the payment system account.

16. The method of claim 15, further comprising:
prior to receiving the funds transfer request:
receiving, in the payment processor computer, a request for a cryptogram, the request for the cryptogram including the second token; and
transmitting the cryptogram from the payment processor computer;
and wherein the received funds transfer request includes the cryptogram.

17. The method of claim 16, further comprising:
generating the cryptogram in the payment processor computer after receiving the request for the cryptogram.

18. The method of claim 15, wherein:
the first request includes a third token different from the first and second tokens, the first request for requesting a fourth token;
the payment processor computer transmits the fourth token with the second token, the fourth token different from the first, second and third tokens.
the payment system account is a first payment system account, the first payment system account represented by the first token;
the third and fourth tokens represent a second payment system account different from the first payment system account; and
the funds transfer request is for requesting transfer of funds from the first payment system account to the second payment system account.

19. The method of claim 15, further comprising:
using the first token to identify an account holder; and
using the second token to identify the account holder.

20. The method of claim 15, wherein the second token is a DPAN (digitized primary account number).
